(19) United States
(12) Patent Application Publication
(10) Pub. No.: US 2026/0246727 A1
(43) Pub. Date: Aug. 20, 2026

(54) APPARATUSES, METHODS AND COMPUTER PROGRAM PRODUCTS FOR ROUTING DATA USING MULTI-AGENT FEDERATED LEARNING

(71) Applicant: Nokia Solutions and Networks Oy, Espoo (FI)

(72) Inventors: Fahad SYED MUHAMMAD, Massy (FR); Afef FEKI, Massy (FR); Muhammad Majid BUTT, Naperville, IL (US)

(21) Appl. No.: 18/993,986

(22) PCT Filed: Jul. 14, 2022
(86) PCT No.: PCT/EP2022/069707

§ 371 Date: Jan. 13, 2025

(51) Int. Cl. H04L 45/02; H04L 45/028; H04W 40/02

(52) U.S. Cl. CPC H04L 45/08; H04L 45/028; H04W 40/02

(57) ABSTRACT

ML based PDCP split for uplink traffic is provided in DC/MC split bearer scenario. When a user device enters a network where ML based PDCP split is operational, it receives an aggregated Q-table from a central entity of the network. It uses the aggregated Q-table to temporarily perform a local exploration and responsively generates a local Q-table. The user device compares respective rewards from both Q-tables, and based on said comparison, selects to use one of the two Q-tables for making a decision to select the respective path for transmitting a PDU, via a respective path, to one amongst a master node and at least one secondary node, and when the local Q-table is selected, it transmits the local Q-table to the central entity (e.g., for updating the aggregated Q-table) only if a predefined condition is present, the updated aggregated Q-table being then distributed to the UEs in the network.

### FIELD OF THE INVENTION

Various example embodiments relate to mobile or wireless telecommunication systems, and in particular to uplink data routing in a dual or multi-connectivity configuration.

### BACKGROUND

Examples of mobile or wireless telecommunication systems may include the universal mobile telecommunications system (UMTS) terrestrial radio access network (UTRAN), long term evolution (LTE) evolved UTRAN (E-UTRAN), LTE-advanced (LTE-A), LTE-A Pro, and/or fifth generation (5G) radio access technology (RAT) or new radio (NR) access technology. 5G or NR wireless systems refer to the next generation (NG) of radio systems and network architecture. It is estimated that NR will provide bitrates on the order of 10-20 Gbit/s or higher and will support at least enhanced mobile broadband (eMBB) and ultra-reliable low-latency-communication (URLLC). NR is expected to deliver extreme broadband and ultra-robust, low latency connectivity and massive networking to support the Internet of things (IoT). With IoT and machine-to-machine (M2M) communication becoming more widespread, there will be a growing need for networks that meet the needs of lower power, high data rates, and long battery life. It should be noted that a node that can provide 5G or NR radio access functionality to a user equipment (UE) (i.e., similar to Node B in E-UTRAN or eNB in LTE) or that can support 5G or NR as well as connectivity to next generation core (also denoted by NGC or 5GC) may be referred to as a next generation or 5G Node B (also denoted by gNB or 5G NB).

### SUMMARY

According to a first example embodiment, there is provided a user device comprising: means for receiving a packet data unit (PDU) of one or more incoming PDUs to be transmitted by the user device, via a respective path, to one amongst a master node and at least one secondary node; means for receiving, once entered a network, an aggregated Q-table from a central entity of the network, the aggregated Q-table including rewards and being shared with the user device and with other user devices (e.g., with any other user devices) also located in the network; means for performing a local exploration during a certain time interval using the aggregated Q-table, and means for generating, in response to the local exploration, a local Q-table, the local Q-table including rewards; means for comparing the respective rewards from the aggregated Q-table and the local Q-table; based on said comparison, means for selecting to use after the certain time interval either the aggregated Q-table or the local Q-table for making a decision to select the respective path for transmitting the PDU; and when the local Q-table is selected, means for determining that a predefined condition is present, and in response to determining that the predefined condition is present, transmitting the local Q-table to the central entity (e.g., for updating the aggregated Q-table).

The local exploration may be a local reinforcement learning (RL) exploration.

The aggregated Q-table may be selected if the rewards from the aggregated Q-table are greater than the rewards from the local Q-table, and the local Q-table may be selected if the rewards from the local Q-table are equal to or greater than the rewards from the aggregated Q-table.

When the local Q-table is selected, the local Q-table may be transmitted to the central entity in response to determining that the predefined condition that a difference between the rewards from the local Q-table and the rewards from the aggregated Q-table is greater than a threshold parameter is present.

The threshold parameter may comprise one amongst a configurable parameter and a predefined parameter.

The user device may further comprise means for receiving, once entered the network, the configurable parameter from the central entity of the network.

According to a second example embodiment, there is provided a central entity. The central entity is located in a network and comprises: means for receiving information that a user device enters the network; means for transmitting an aggregated Q-table to the user device, as described in the above first example embodiment; means for receiving and storing one or more local Q-tables, said local Q-table (e.g., each local Q-table) being received from a respective user device; means for determining that a predefined triggering condition is present; in response to determining that the predefined triggering condition is present, means for applying a federated learning based on the one or more local Q-tables; and in response to applying the federated learning, means for generating an updated aggregated Q-table and means for transmitting the updated aggregated Q-table to the respective user devices (e.g., to each of the respective user devices) in the network and to other user devices (e.g., to each of any other user devices) also located in the network.

The means for applying the federated learning may be further configured for aggregating the one or more local Q-tables and for updating the aggregated Q-table based on the one or more local Q-tables as to obtain the updated aggregated Q-table.

The federated learning may be applied in response to determining that the predefined triggering condition that a number of the one or more local Q-tables is above a threshold value is present and/or that the predefined triggering condition that a timer has just expired is present. The number of the one or more local Q-tables refers to the amount of the one or more local Q-tables, i.e., the local Q-tables that have been transmitted from the respective user devices to the central entity for those user devices whose predefined condition of local Q-table transmission was present (i.e., verified). In other terms, the number of the one or more local Q-tables refers to the number of local Q-table updates that have been transmitted as a result of meeting the predefined condition of local Q-table transmission.

The central entity may be located in the network either inside a serving base station for the respective user devices or inside an operations, administration and maintenance, OAM, entity (or more specifically inside a radio access network intelligent controller, RIC).

According to a third example embodiment, there is provided a method performed at a user device, as described in the above first example embodiment, the method comprising: receiving a packet data unit (PDU) of one or more incoming PDUs to be transmitted by the user device, via a respective path, to one amongst a master node and at least one secondary node; receiving, once the user device has entered a network, an aggregated Q-table from a central entity, as described in the above second example embodiment, of the network, the aggregated Q-table including rewards and being shared with the user device and with other user devices (e.g., with any other user devices) also located in the network; performing a local exploration during a certain time interval using the aggregated Q-table and generating, in response to the local exploration, a local Q-table, the local Q-table including rewards; comparing the respective rewards from the aggregated Q-table and the local Q-table; based on said comparison, selecting to use after the certain time interval either the aggregated Q-table or the local Q-table for making a decision to select the respective path for transmitting the PDU; and when the local Q-table is selected, determining that a predefined condition is present, and in response to determining that the predefined condition is present, transmitting the local Q-table to the central entity (e.g., for updating the aggregated Q-table).

The local exploration may be a local reinforcement learning (RL) exploration.

The aggregated Q-table may be selected if the rewards from the aggregated Q-table are greater than the rewards from the local Q-table, and the local Q-table may be selected if the rewards from the local Q-table are equal to or greater than the rewards from the aggregated Q-table.

When the local Q-table is selected, the local Q-table may be transmitted to the central entity in response to determining that the predefined condition that a difference between the rewards from the local Q-table and the rewards from the aggregated Q-table is greater than a threshold parameter is present.

The threshold parameter may comprise one amongst a configurable parameter and a predefined parameter.

The method may further comprise: receiving, once the user device has entered the network, the configurable parameter from the central entity of the network.

According to a fourth example embodiment, there is provided a method performed at a central entity, as described in the above second example embodiment, of a network, the method comprising: receiving information that a user device enters the network; transmitting an aggregated Q-table to the user device, as described in the above first example embodiment; receiving and storing one or more local Q-tables, said local Q-table (e.g., each local Q-table) being received from a respective user device; determining that a predefined triggering condition is present; in response to determining that the predefined triggering condition is present, applying a federated learning based on the one or more local Q-tables; and in response to applying the federated learning, generating an updated aggregated Q-table and transmitting the updated aggregated Q-table to the respective user devices (e.g., to each of the respective user devices) in the network and to other user devices (e.g., to each of any other user devices) also located in the network.

The step of applying the federated learning may comprise aggregating the one or more local Q-tables and updating the aggregated Q-table based on the one or more local Q-tables as to obtain the updated aggregated Q-table.

The federated learning may be applied in response to determining that the predefined triggering condition that a number of the one or more local Q-tables is above a threshold value is present and/or that the predefined triggering condition that a timer has just expired is present.

The central entity may be located in the network either inside a serving base station for the respective user devices or inside an operations, administration and maintenance, OAM, entity (or more specifically inside a radio access network intelligent controller, RIC).

According to a fifth example embodiment, there is provided a system comprising means for receiving a packet data unit, PDU, of one or more incoming PDUs to be transmitted by a user device of one or more user devices, via a respective path, to one amongst a master node and at least one secondary node; means for receiving, once the user device has entered a network, an aggregated Q-table from a central entity of the network, the aggregated Q-table including rewards and being shared with the user device and with other user devices also located in the network; means for performing a local exploration during a certain time interval using the aggregated Q-table, and means for generating, in response to the local exploration, a local Q-table, the local Q-table including rewards; means for comparing the respective rewards from the aggregated Q-table and the local Q-table; based on said comparison, means for selecting to use after the certain time interval either the aggregated Q-table or the local Q-table for making a decision to select the respective path for transmitting the PDU; when the local Q-table is selected, means for determining that a predefined condition is present, and in response to determining that the predefined condition is present, means for transmitting the local Q-table to the central entity (e.g., for updating the aggregated Q-table); and means for receiving information that a user device enters the network; means for transmitting the aggregated Q-table to the user device; means for receiving and storing one or more local Q-tables, said local Q-table being received from a respective user device; means for determining that a predefined triggering condition is present; in response to determining that the predefined triggering condition is present, means for applying a federated learning based on the one or more local Q-tables; and in response to applying the federated learning, means for generating an updated aggregated Q-table and means for transmitting the updated aggregated Q-table to the respective user devices in the network and to other user devices also located in the network.

According to a sixth example embodiment, there is provided a computer program comprising instructions stored thereon for performing the method of the above third example embodiment or the method of the above fourth example embodiment or a combination thereof.

According to a seventh example embodiment, there is provided a user device comprising: at least one processor; and at least one memory storing instructions that, when executed by the at least one processor, cause the user device at least to: receive a packet data unit (PDU) of one or more incoming PDUs to be transmitted by the user device, via a respective path, to one amongst a master node and at least one secondary node; receive, once entered a network, an aggregated Q-table from a central entity of the network, the aggregated Q-table including rewards and being shared with the user device and with other user devices (e.g., with any other user devices) also located in the network; perform a local exploration during a certain time interval using the aggregated Q-table, and generate, in response to the local exploration, a local Q-table, the local Q-table including rewards; compare the respective rewards from the aggregated Q-table and the local Q-table; based on said comparison, select to use after the certain time interval either the aggregated Q-table or the local Q-table for making a decision to select the respective path for transmitting the PDU; and when the local Q-table is selected, determine that a predefined condition is present, and in response to determining that the predefined condition is present, transmit the local Q-table to the central entity (e.g., for updating the aggregated Q-table).

According to an eighth example embodiment, there is provided a central entity comprising: at least one processor; and at least one memory storing instructions that, when executed by the at least one processor, cause the central entity located in a network at least to: receive information that a user device enters the network; transmit an aggregated Q-table to the user device; receive and store one or more local Q-tables, said local Q-table (e.g., each local Q-table) being received from a respective user device; determine that a predefined triggering condition is present; in response to determining that the predefined triggering condition is present, apply a federated learning based on the one or more local Q-tables; and in response to applying the federated learning, generate an updated aggregated Q-table and transmit the updated aggregated Q-table to the respective user devices (e.g., to each of the respective user devices) in the network and to user devices (e.g., to each of any other user devices) also located in the network.

According to a ninth example embodiment, there is provided a system comprising at least one first processor; and at least one first memory storing instructions that, when executed by the at least one processor, cause the system at least to: receive a packet data unit, PDU, of one or more incoming PDUs to be transmitted by a user device of one or more user devices, via a respective path, to one amongst a master node and at least one secondary node; receive, once the user device has entered a network, an aggregated Q-table from a central entity of the network, the aggregated Q-table including rewards and being shared with the user device and with other user devices also located in the network; perform a local exploration during a certain time interval using the aggregated Q-table, and generate, in response to the local exploration, a local Q-table, the local Q-table including rewards; compare the respective rewards from the aggregated Q-table and the local Q-table; based on said comparison, select to use after the certain time interval either the aggregated Q-table or the local Q-table for making a decision to select the respective path for transmitting the PDU; and when the local Q-table is selected, determine that a predefined condition is present, and in response to determining that the predefined condition is present, transmit the local Q-table to the central entity, and receive information that a user device enters the network; transmit the aggregated Q-table to the user device; receive and store one or more local Q-tables, said local Q-table being received from a respective user device; determine that a predefined triggering condition is present; in response to determining that the predefined triggering condition is present, apply a federated learning based on the one or more local Q-tables; and in response to applying the federated learning, generate an updated aggregated Q-table and transmit the updated aggregated Q-table to the respective user devices in the network and to other user devices also located in the network.

According to a tenth example embodiment, there is provided a non-transitory computer readable medium comprising program instructions stored thereon for performing at a user device at least the following: receiving a packet data unit, PDU, of one or more incoming PDUs to be transmitted by the user device, via a respective path, to one amongst a master node and at least one secondary node; receiving, once the user device has entered a network, an aggregated Q-table from a central entity of the network, the aggregated Q-table including rewards and being shared with the user device and with other user devices (e.g., with any other user devices) also located in the network; performing a local exploration during a certain time interval using the aggregated Q-table, and generating, in response to the local exploration, a local Q-table, the local Q-table including rewards; comparing the respective rewards from the aggregated Q-table and the local Q-table; based on said comparison, selecting to use after the certain time interval either the aggregated Q-table or the local Q-table for making a decision to select the respective path for transmitting the PDU; and when the local Q-table is selected, determining that a predefined condition is present, and in response to determining that the predefined condition is present, transmitting the local Q-table to the central entity (e.g., for updating the aggregated Q-table).

According to an eleventh example embodiment, there is provided a non-transitory computer readable medium comprising program instructions stored thereon for performing at a central entity of a network at least the following: receiving information that a user device enters the network; transmitting an aggregated Q-table to the user device; receiving and storing one or more local Q-tables, said local Q-table (e.g., each local Q-table) being received from a respective user device; determining that a predefined triggering condition is present; in response to determining that the predefined triggering condition is present, applying a federated learning based on the one or more local Q-tables; and in response to applying the federated learning, generating an updated aggregated Q-table and transmitting the updated aggregated Q-table to the respective user devices (e.g., to each of the respective user devices) in the network and to other user devices (e.g., to each of any other user devices) also located in the network.

According to a twelfth example embodiment, there is provided a non-transitory computer readable medium comprising program instructions stored thereon for performing the method of the above third example embodiment or the method of the above fourth example embodiment or a combination thereof.

According to a thirteenth example embodiment, there is provided a non-volatile tangible memory medium comprising program instructions stored thereon for performing the method of the above third example embodiment or the method of the above fourth example embodiment or a combination thereof.

According to a fourteenth example embodiment, there is provided an apparatus comprising circuitry configured to perform the method of the above third example embodiment or the method of the above fourth example embodiment or a combination thereof.

In the above, many different example embodiments have been described. It should be appreciated that further example embodiments may be provided by the combination of any two or more of the example embodiments described above.

Various other example embodiments are also described in the following detailed description and in the attached claims.

### BRIEF DESCRIPTION OF THE DRAWINGS

Some example embodiments will now be described with reference to the following accompanying drawings:

FIG. 1 shows an example embodiment of a communication system;

FIG. 2 shows an example embodiment of a schematic representation of Little's law for a stable and loss free queueing system;

FIG. 3 shows an example embodiment of a multilayer NN structure with a single hidden layer;

FIG. 4 shows an example embodiment of a single computational node from the multilayer NN structure of FIG. 3;

FIG. 5 shows an example embodiment of RL based PDCP split for UL traffic;

FIG. 6 shows an example embodiment of a network view of a multi-agent federated learning RL solution for UL PDCP split;

FIG. 7 shows an example embodiment of a flow chart describing a method of the multi-agent federated learning RL solution for UL PDCP split at the UE side;

FIG. 8 shows an example embodiment of a flow chart describing a method of the multi-agent federated learning RL solution for UL PDCP split at the network side;

FIG. 9 shows an example embodiment of a signaling diagram for a signaling between a UE device as a user device and a gNB entity as a central entity for a method of the multi-agent federated learning RL solution for UL PDCP split;

FIG. 10 shows an example embodiment of a signaling diagram for a signaling between a UE device as a user device and an OAM entity as a central entity via a gNB entity for a method of the multi-agent federated learning RL solution for UL PDCP split;

FIG. 11 shows an example embodiment of non-transitory computer readable media;

FIG. 12 shows an example embodiment of an apparatus.

### DETAILED DESCRIPTION

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. It should be appreciated that the embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

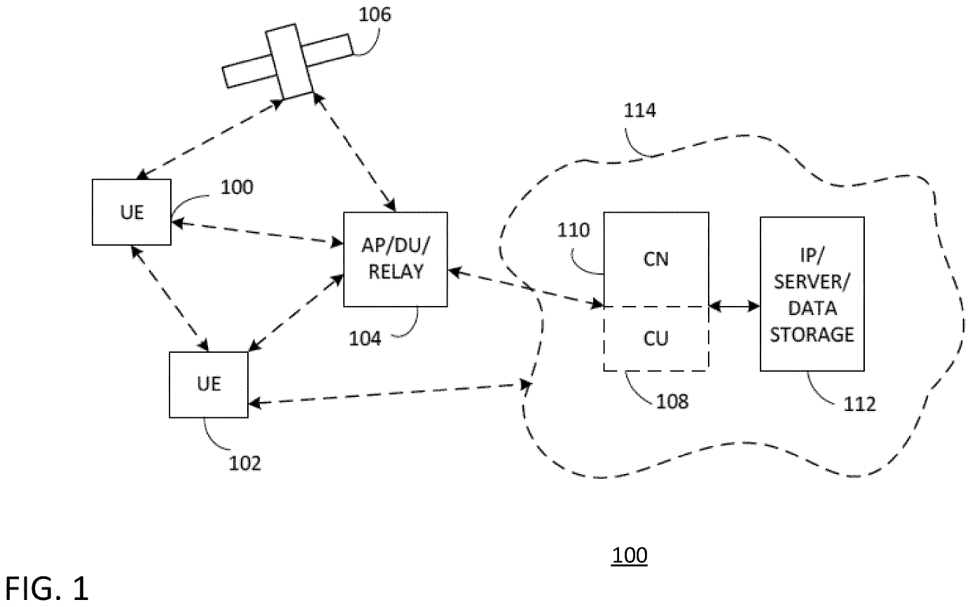

FIG. 1 schematically depicts an exemplifying communication system 100 only showing some elements and functional entities, all being logical units, whose implementation may differ from what is shown. Although the connections shown in FIG. 1 are logical connections; the actual physical connections may be different. It should be appreciated that the communication system 100 may typically comprise also other functions and structures than those shown in FIG. 1. However, the embodiments are not restricted to the communication system 100 given as an example and it should be thus appreciated that the solution may applied to other communication systems provided with necessary properties.

The example of the communication system 100 of FIG. 1 shows a part of an exemplifying radio access network.

FIG. 1 shows user devices 102-a and 102-b configured to be in a wireless connection on one or more communication channels in a cell with an access node (such as (e/g) NodeB) 104 providing the cell. The physical link from a user device to a (e/g) NodeB is called uplink (UL) or reverse link and the physical link from the (e/g) NodeB to the user device is called downlink (DL) or forward link. It should be appreciated that (e/g) NodeBs or their functionalities may be implemented by using any entity, e.g., any node, host, server or access point, suitable for such a usage.

A communication system may typically comprise more than one (e/g) NodeB in which case the (e/g) NodeBs may also be configured to communicate with one another over links, wired or wireless, designed for the purpose. These links may be used for signalling purposes. The (e/g) NodeB may be a computing device configured to control the radio resources of the communication system it is coupled to. The NodeB may also be referred to as a base station, an access point or any other type of interfacing device including a relay station capable of operating in a wireless environment. The (e/g) NodeB may include or be coupled to transceivers. From the transceivers of the (e/g) NodeB, a connection may be provided to an antenna unit that may establish bi-directional radio links to user devices. The antenna unit may comprise a plurality of antennas or antenna elements. The (e/g) NodeB may be further connected to core network 110 (CN or next generation core (NGC)). Depending on the system, the counterpart on the CN side may be a serving gateway (S-GW, routing and forwarding user data packets), packet data network gateway (P-GW), for providing connectivity of user devices (UEs) to, e.g., external packet data networks, mobile management entity (MME), and so on.

The user device (also called user equipment (UE), user terminal, terminal device, and so on) illustrates one type of an apparatus to which resources on the air interface may be allocated and assigned, and thus any feature described herein with a user device may be implemented with a corresponding apparatus, such as a relay node. An example of such a relay node may be a layer 3 relay (self-backhauling relay) towards the base station.

The user device may typically refer to a portable computing device that may include wireless mobile communication devices operating with or without a subscriber identification module (SIM), including, but not limited to, the following types of devices: mobile station (e.g., mobile phone), smartphone, personal digital assistant (PDA), handset, device using a wireless modem (e.g., alarm or measurement device), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of things (IoT) network which is a scenario in which objects are provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation may be then carried out in the cloud. The user device (or in some embodiments, a layer 3 relay node) may be configured to perform one or more of user equipment functionalities. The user device may also be called a subscriber unit, a mobile station, a remote terminal, an access terminal, a user terminal or a user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected (ICT) devices (e.g., sensors, actuators, processors microcontrollers, and so on) embedded in physical objects at different locations. Mobile cyber physical systems, in which the physical system in question has inherent mobility, are a subcategory of cyber-physical systems. Examples of mobile physical systems may include mobile robotics and electronics transported by humans or animals.

Additionally, although the apparatuses have been depicted as single entities, different units, processors and/or memory units (not all shown in FIG. 1) may be implemented. 5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including, e.g., vehicular safety, different sensors and real-time control. 5G is expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHZ-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, IoT (massive connectivity and/or latency critical), critical communications (autonomous vehicles, traffic safety, real-time analytics, time-critical control, healthcare applications).

The communication system 100 may also be able to communicate with other networks, such as a public switched telephone network or the Internet 112, or utilize services provided by them. The communication network may also be able to support the usage of cloud services, for example, at least a part of core network operations may be carried out as a cloud service (as depicted in FIG. 1 by the cloud 114). The communication system 100 may also comprise a central control entity, or a like, providing facilities for networks of different operators to cooperate, for example, in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations may be distributed among a plurality of servers, nodes or hosts. Application of cloudRAN architecture enables RAN real time functions to be carried out at the RAN side (in a distributed unit, DU 104) and non-real time functions to be carried out in a centralized manner (in a centralized unit, CU 108).

It should also be understood that the distribution of labor between core network operations and base station operations may differ from that of the LTE or even be non-existent. Some other technology advancements to be probably used may be Big Data and all-IP, which may change the way networks are being constructed and managed. 5G (or new radio, NR) networks are being designed to support multiple hierarchies, where MEC servers may be placed between the core and the base station or nodeB (gNB). It should be appreciated that MEC can be applied in 4G networks as well.

5G may also utilize satellite communication to enhance or complement the coverage of 5G service, for example, by providing backhauling. Possible use cases may comprise providing service continuity for machine-to-machine (M2M) or IoT devices or for passengers on board of vehicles, or ensuring service availability for critical communications and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite 106 in the mega-constellation may cover several satellite-enabled network entities that create on-ground cells. The on-ground cells may be created through an on-ground relay node 104 or by a gNB located on-ground or in a satellite.

It should be appreciated that the depicted system 100 is only an example of a part of a radio access system and that, in practice, the system 100 may comprise a plurality of (e/g) NodeBs, the user device may have an access to a plurality of radio cells and the system 100 may comprise also other apparatuses, such as physical layer relay nodes or other network elements, and so on. At least one of the (e/g) NodeBs may be a Home (e/g) nodeB. Additionally, in a geographical area of a radio communication system, a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. Typically, in multilayer networks, one access node may provide one kind of a cell or cells, and a plurality of (e/g) NodeBs may thus be required to provide such a network structure.

For fulfilling the need for improving the deployment and performance of communication systems, the concept of “plug-and-play” (e/g) NodeBs has been introduced. Typically, a network which is able to use “plug-and-play” (e/g) Node Bs, may include, in addition to Home (e/g) NodeBs (H (e/g) nodeBs), a home node B gateway, or HNB-GW (not shown in FIG. 1). A HNB Gateway (HNB-GW), which is typically installed within an operator's network, may aggregate traffic from a large number of HNBs back to a core network.

Dual connectivity (DC), as defined in 3GPP TR 36.842 v0.2.0, is used to refer to operation where a given UE (e.g., a mobile device, stationary device, IoT device, or any other device capable of communication with a wireless or wired communication network) consumes radio resources provided by at least two different network points connected with non-ideal backhaul. DC allows a user to simultaneously communicate with two or more different network nodes. Multi-connectivity (MC) extends the DC principle in the form of simultaneous connectivity to different RATs.

3GPP TR 38.801 V14.0.0 discloses different architecture and RAN-level interworking options for which, for example, a UE can connect to the network using 4G (E-UTRA) access and/or 5G (NR) access connecting to the evolved packet core (EPC) or the NGC. Therein, the LTE evolved node B (LTE eNB) can provide the E-UTRA U-plane and C-plane protocol terminations towards the UE, while the gNB can provide the NR U-plane and C-plane protocol terminations towards the UE. These deployment options have been primarily grouped into standalone (SA) category where there is only one independent access network (either E-UTRA or NR) that is connected to either the EPC or the NGC, and non-standalone (NSA) category where both E-UTRA and NR RATs are present, one of the access networks (E-UTRA, NR) assisting the other in connecting to either an EPC or a NGC. RAN-level interworking is required in a NSA where 5G (NR) cannot be used without LTE.

For UL traffic in DC/MC split bearer scenario, data split between different legs (e.g., 4G leg for a path towards a secondary node and 5G leg for a path towards a master node) is done at a packet data convergence protocol (PDCP) layer and is handled by the UE. For further details, PDCP specification may be found in, e.g., 3GPP TS 36.323 for LTE and TS 38.323 for 5G.

The PDCP layer may comprise a data split function entity (also denoted as a splitter) whose function is to decide whether a PDCP packet data unit (PDU) from one or more PDUs is to be transmitted by the UE, via a respective path, to one amongst the master node (e.g., gNB) and at least one secondary node (e.g., eNB). This is contrary to the PDCP duplication use case where for high priority bearers/applications, packets are sent on both legs (i.e., 4G leg for the path towards the secondary node (e.g., eNB) and 5G leg for the path towards the master node (e.g., gNB)).

In the example embodiment of the present PDCP split use case, the data split function entity may be configured to split the incoming UL data stream (i.e., the PDUs arriving at the UE) into at least two sub-streams using at least two different paths, that is, a direct path via the master node and a respective path via at least one secondary node. These data packets (i.e., PDUs) may then be collected and reordered at the PDCP layer of the master node at the network side.

The decision of the splitter of the UE to transmit a PDCP PDU to one amongst the master node (e.g., gNB) and at least one secondary node (e.g., eNB) may be based on an estimation of the delay of transmission for the different paths. It may also be based on a percentage of PDUs to be transmitted, the percentage being, e.g., dictated by the network.

In an example embodiment, the splitter may calculate, by means of a mathematical or analytic formulation or algorithm, an estimation of the delay of transmission for each path that a PDU can experience and may then select to route the PDU towards the shortest path in terms of time delay, so that the PDU can reach the target node (i.e., either the master node or the secondary node) at the network side in a faster way.

In an example embodiment, the mathematical formulation may be based on Little's law to calculate the estimated delays of transmission for different paths for incoming PDUs.

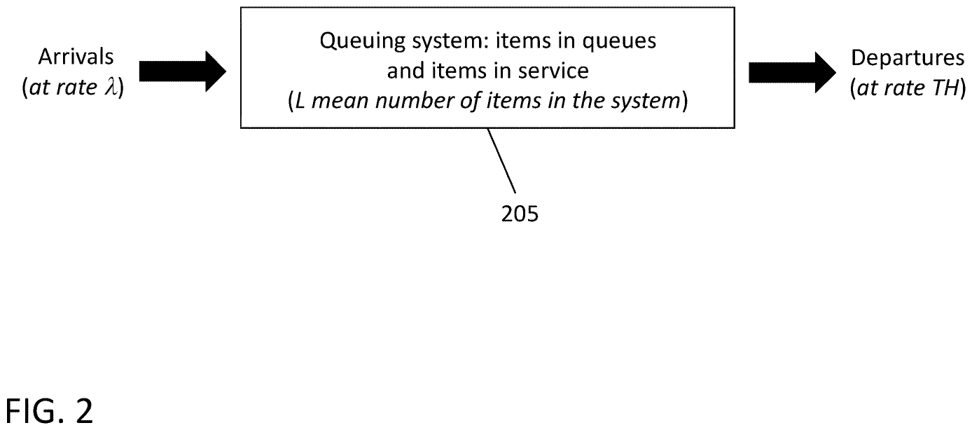

FIG. 2 shows an example embodiment of a schematic representation of Little's law for a stable and loss free queueing system 205.

Referring to FIG. 2, the mean sojourn time W of an item (e.g., PDU) in a queueing system 205 is given by the following Little's law relationship:

$$W = L / λ = L / TH \qquad ( 1 )$$

where “λ” is the rate at which the items (e.g., PDUs) arrive 210 at the queuing system 205, “L” is the mean number of items in the queueing system 205, and “TH” is the rate at which the items (e.g., PDUs) depart from/leave 215 the queueing system 205.

In an attempt to improve estimation (or prediction) of transmission delays in terms of accuracy in the case of dynamic load and delay conditions, an example embodiment may consist in using a machine learning (ML) model instead of the above mathematical formulation based on Little's law.

For UL data traffic, the data split function entity of the PDCP layer of the UE may be replaced by the ML model, which may be configured to act as an estimator whose function may be to estimate (or predict) the delays of transmission for each path that a PDU can experience when outputting from the splitter to reach the master node (e.g., gNB) or the secondary node (e.g., eNB).

The ML model may comprise a neural network (NN) or an artificial neural network (ANN) model, itself comprising, for example, but not limited to, a deep neural network (DNN) (also known as feedforward neural network (FNN) or multilayer perceptron) model, a recurrent neural network (RNN) model or a convolutional neural network (CNN) model, among others.

Deep learning (DL) (also known as deep structured learning or hierarchical learning) is part of a broader family of ML methods based on the layers used in ANNs.

An ANN comprises a set of rules that are designed to execute tasks such as regression, classification, clustering, and pattern recognition. The ANNs can achieve such objectives with a learning procedure, where they are shown various examples of input data, along with the desired output. With this, they learn to identify the proper output for any input within the training data manifold. Learning by using labels is called supervised learning and learning without labels is called unsupervised learning. Deep learning typically requires a large amount of input data.

A DNN is an artificial neural network comprising multiple hidden layers between the input and output layers. Training of DNN allows it to find the correct mathematical manipulation to transform the input into the proper output even when the relationship is highly non-linear and/or complicated.

The hidden layers comprise nodes (also known as neurons or units), where the computation takes place. A node combines input data with a set of coefficients, or weights, that either amplify or dampen that input, thereby assigning significance to inputs with regard to the task the algorithm is trying to learn. The input-weight products are added and the weighted sum is passed through a node's so-called activation function (also known as transfer function), to determine whether and to what extent that signal should progress further through the network to affect the ultimate outcome, such as an act of classification. In the process, the NNs learn to recognize correlations between certain relevant features and optimal results. It should be noted that the activation function is typically a non-linear function whose purpose is to introduce non-linearity into the output of a neuron, thereby allowing the neuron to learn non-linear representations from non-linear real-world data.

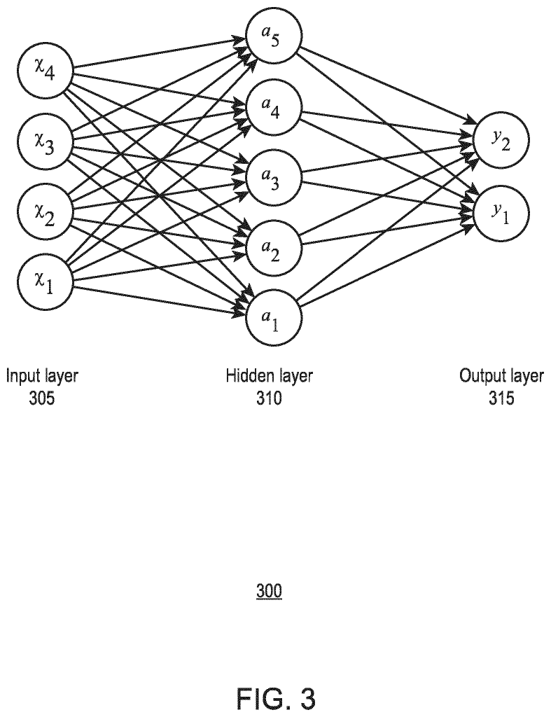

FIG. 3 shows an example embodiment of a multilayer NN structure 300 with a single hidden layer 310. As depicted, the input layer 305 comprises four inputs denoted as x1, x2, x3, x4, the hidden layer 310 comprises five (hidden) nodes denoted as a1, a2, a3, a4, a5, and the output layer 315 comprises two outputs denoted as y1, y2.

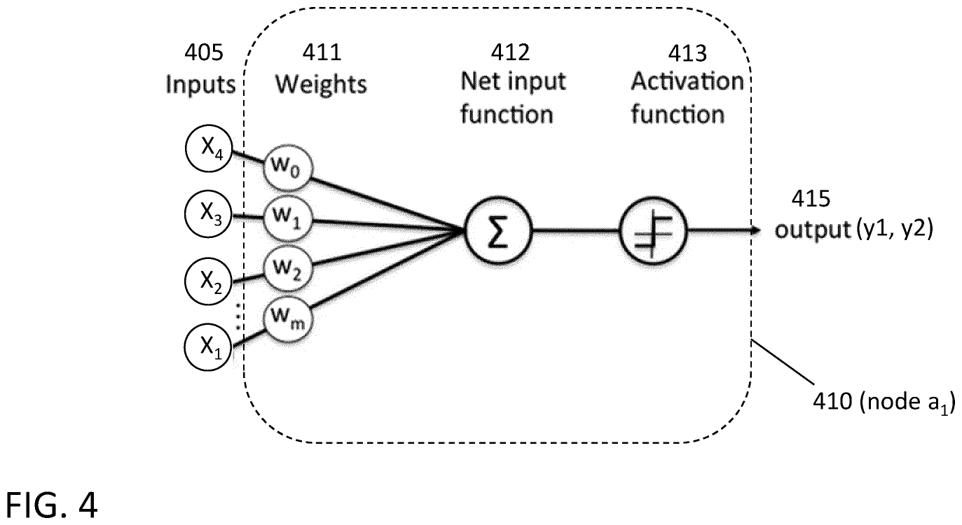

FIG. 4 shows an example embodiment of a single computational node 410 from the multilayer NN structure 300 of FIG. 3. As depicted, the computational node 410 is the (hidden) node a1 in which each input 405 (x1, x2, x3, x4) is associated with a respective weight 411 (w1, w2, w3, w4), the input-weight products are added at the net input function 412 and the resulting sum is passed through the activation function 413 that defines the output 415 of the (hidden) node a1 given the inputs 405 (x1, x2, x3, x4).

In the case of classification, the output of DL networks can be considered as a likelihood of a particular outcome, such as in this case a probability of decoding success of a frame. In this case, the number of layers may vary proportional to the number of used input data. However, when the number of input data is high, the accuracy of the outcome is more reliable. On the other hand, when there are fewer layers, the computation might take less time and thereby reduce the latency. However, this highly depends on the specific DNN architecture and/or the computational resources.

Initial weights of the model can be set in various alternative ways. During the training phase, they are adapted to improve the accuracy of the process based on analyzing errors in decision making. Training a model is basically a trial and error activity. In principle, each node of a NN makes a decision (input*weight) and then compares this decision to collected data to find out the difference to the collected data. In other words, it determines the error, based on which the weights are adjusted. Thus, the training of the model can be considered a corrective feedback loop.

Typically, a NN model is trained using a stochastic gradient descent optimization algorithm for which the gradients are calculated using the backpropagation algorithm. The gradient descent algorithm seeks to change the weights so that the next evaluation reduces the error, meaning the optimization algorithm is navigating down the gradient (or slope) of error. It is also possible to use any other suitable optimization algorithm if it can provide sufficiently accurate weights.

In the context of an optimization algorithm, the function used to evaluate a candidate solution (i.e., a set of weights) is referred to as the objective function. Typically, with NNs, where the target is to minimize the error, the objective function is often referred to as a cost function or a loss function. In adjusting weights, any suitable method such as, e.g., mean squared error (MSE), maximum likelihood (MLE), and cross entropy, can be used as a loss function.

As for the activation function of a node, it defines the output of that node given an input or set of inputs. It calculates a weighted sum of inputs, perhaps adds a bias (e.g., 1) and then makes a decision as “activate” or “not activate” based on a decision threshold as a binary activation or using an activation function that gives a nonlinear decision function. Any suitable activation function (e.g., sigmoid, rectified linear unit (ReLU), normalized exponential function (softmax), softplus, tanh, and so on) can be used. In DL, the activation function is usually set at the layer level and applies to all neurons in that layer. The output is then used as input for the next node and so on until a desired solution to the original problem is found.

Typically, performance of a ML model/algorithm for estimating (or predicting) transmission delays with an enhanced accuracy largely depends upon data size and experiences to be used for training the ML model. And in the example case where a UE entering a network inherits the ML model, the UE may not have data and experiences enough to optimize its ML model, thereby leading to suboptimal or downgraded throughput performance during the training/learning/exploration phase of its ML model. In particular, in an example scenario where the “new” UE (with respect to those other UEs previously entered the network) inherits an ML model optimized for other UEs and starts using it, there may be no guarantee that the ML model best suits its local environment. In another example scenario where the UE starts its training/learning/exploration from scratch with the available data, this may produce very suboptimal results during the training/learning/exploration phase.

Thus, in an attempt to further improve the above estimation (or prediction) of transmission delays in terms of accuracy in the case of dynamic load and delay conditions, a solution may be based on federated learning (FL) wherein an already learned/trained ML model at a central entity of a network may be shared for a limited time interval to any UE(s) entering the network as a new serving area and used by the UE(s), once entered the network, for local exploration during the limited time interval. This will have the benefit of allowing these “new” UEs to (kick) start with near-optimal performance for UL traffic in split bearer case and, if needed, to further enrich the centralized policy of the central entity of the network, thus improving the overall UL throughput key performance indicators (KPIs).

In an example embodiment, the training of the ML model to make a sequence of decisions is based on reinforcement learning (RL). Further details about RL may for example be found in: “Reinforcement Learning: An Introduction”, Second Edition, Richard S. Sutton and Andrew G. Barto, MIT Press, Cambridge, MA, 2018.

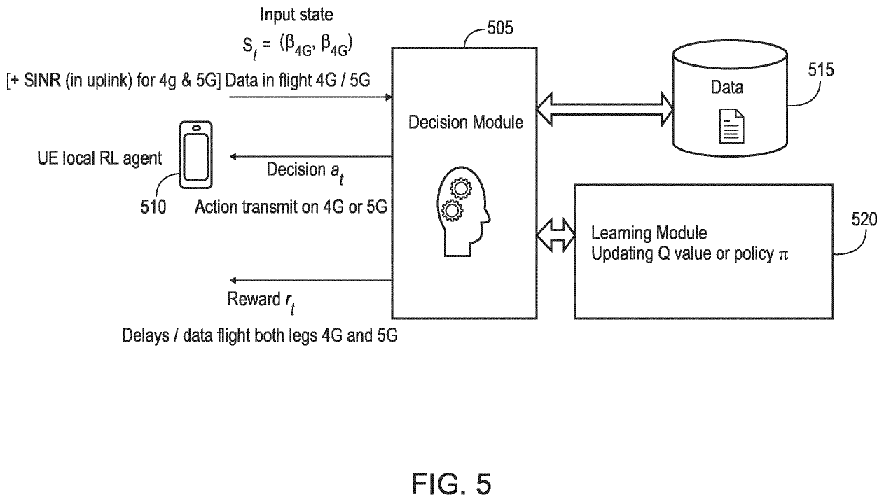

FIG. 5 shows an example embodiment of reinforcement learning (RL) based PDCP split for UL traffic inside a UE device.

As depicted, the decision module 505 receives the input state sₜ which is given by: sₜ=(β_{4G}, β_{5G}, γ_{4G}, γ_{5G}), where the data set includes B representing the data in flight [in bits] for each leg (i.e., 4G leg for the path towards the secondary node (e.g., eNB), 5G leg for the path towards the master node (e.g., gNB)) and γ representing the UL signal-to-interference-plus-noise ratio (SINR) [in dB] for each leg (i.e., 4G leg, 5G leg). This radio condition parameter SINR is available at the user device side. Reference signal received power (RSRP)/reference signal received quality (RSRQ) may also be used to enrich the data set. It should be noted that the data in flight basically refers to the number of PDUs in queue to be transmitted by the PDCP layer.

Based on the received input state sₜ, the decision module 505 provides a UE local RL agent 510 with a routing decision as an action aₜ corresponding to a transmission on either 4G leg or 5G leg.

The decision module 505 also provides a reward rₜ for the action at which is given by: rₜ=(d_{4G}, d_{5G}), where d represents the delay of transmission on each leg (i.e., 4G leg, 5G leg). The reward rₜ may be optionally given by: rₜ=(d_{4G}, d_{5G}, β_{4G}, β_{5G}), where d represents the delay of transmission on each leg (i.e., 4G leg, 5G leg) and β represents the data in flight [in bits] for each leg (i.e., 4G leg for the path towards the secondary node (e.g., eNB), 5G leg for the path towards the master node (e.g., gNB)).

The decision module 505 takes the splitting decision for incoming PDCP PDUs coming from the data module 515. The learning module 520 shows how the policy TT, i.e., the RL policy, of the ML based PDCP splitter is updated. Typically, the policy π is a map from states to actions, Q_{π}(s, a) is the current policy π of action a from state s, and r is the reward for the action.

It should be noted that the decision module 505, the data module 515 and the learning module 520 are located inside the UE device 510, and that they are displayed in zooming way only for ease of illustration.

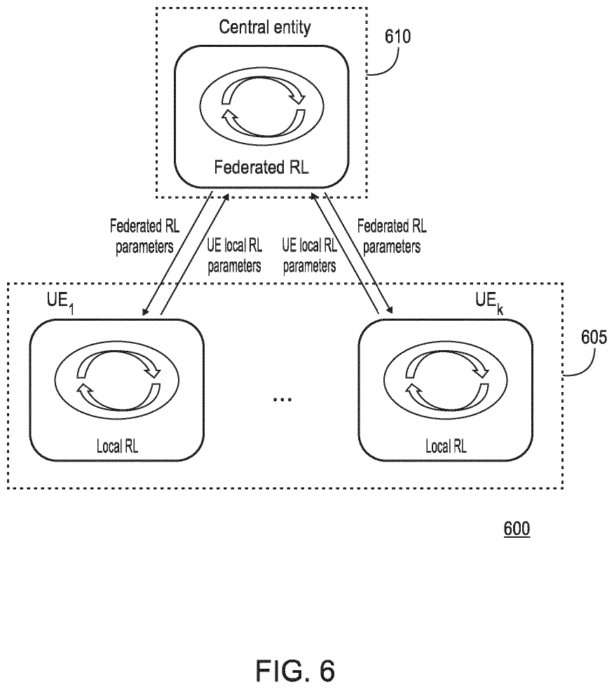

FIG. 6 shows an example embodiment of a network view of a multi-agent federated learning RL solution 600 for UL PDCP split.

As depicted, a plurality of UEs 605 (UE₁, . . . , UEₖ) individually run a local RL model while a central entity 610 runs a federated RL model. The central entity 610 may for example be a serving gNB or an operations, administration and maintenance, OAM, entity (e.g., more specifically a RAN intelligent controller (RIC)) via its serving gNB.

Upon verification of some predefined conditions, the UEs 605 can receive federated RL parameters from the central entity 610 and the UEs 605 can transmit their local RL parameters to the central entity 610. The multi-agent federated learning RL solution 600 allows these local RL parameters to be aggregated inside the central entity 610 along with their radio conditions in order to benefit from the individual experience of each of these UEs 605. This “indirect” cooperation between the UEs 605 via the central entity 610 allows to provide valuable initialization parameters for helping a new UE entering the network (kick) start with optimal performance. Thereby, the new UE entering the network may take benefit from experience and learning from other UEs in the network instead of realizing its own learning from scratch with the risk of increasing convergence time of the Q-learning algorithm.

The multi-agent federated learning RL solution for UL PDCP split is described in more details in the following for the UE side and for the network side.

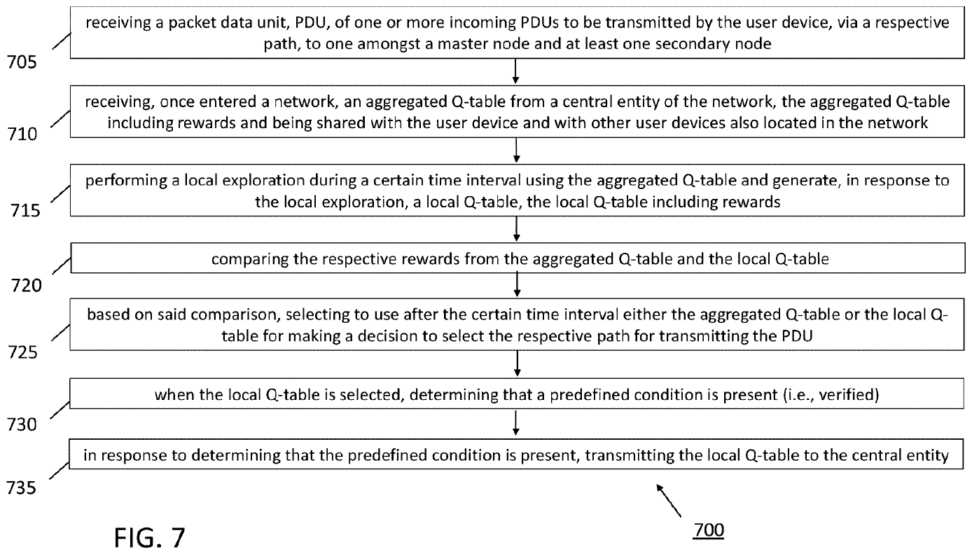

FIG. 7 shows an example embodiment of a flow chart describing a method 700 of the multi-agent federated learning RL solution for UL PDCP split at the UE side.

In step 705, a user device (e.g., a UE) receives a PDU of one or more incoming PDUs to be transmitted by itself, via a respective path, to one amongst a master node (e.g., gNB) and at least one secondary node (eNB).

In step 710, the user device receives, once entered a network corresponding to a new service area, an aggregated Q-table (as an initial Q-table) from a central entity (e.g., from a serving gNB or from an OAM entity (e.g., more specifically from a RIC) via its serving gNB with which the user device is in connection) of the network, the aggregated Q-table including rewards and being shared with the user device and with other user devices (e.g., UEs) also located in the network or any other user devices (e.g., UEs) also located in the network. It should be noted that a Q-table gives the perceived (or expected) reward for different actions for different states, such that the Q-table comprises three components: state, action, reward.

In step 715, the user device uses the aggregated Q-table to perform a local exploration during a certain time interval and generate (or compute), in response to the local exploration, a local Q-table (as a new Q-table), the local Q-table including rewards. Thus, the time interval may be shorter by taking benefit from experience and learning from other user devices than the time interval needed to realize its own learning from scratch.

In step 720, the user device compares the respective rewards from the aggregated Q-table and the local Q-table. In particular, the user device compares the average rewards to determine whether the rewards from the aggregated Q-table are smaller or greater than the rewards from the local Q-table.

In step 725, based on said comparison, the user device selects to use after the certain time interval either the aggregated Q-table or the local Q-table for making a (routing) decision to select the respective path for transmitting the PDU. In particular, the aggregated Q-table is selected if the rewards from the aggregated Q-table are greater than the rewards from the local Q-table, and the local Q-table is selected if the rewards from the local Q-table are equal to or greater than the rewards from the aggregated Q-table.

In the case where the rewards from the local Q-table are greater than the rewards from the aggregated Q-table, this implies that the user device should better use its newly computed Q-table, that is its local Q-table, for making the (routing) decision. However, the user device shall still make one more decision as to whether to send or not its local Q-table to the central entity of the network for enriching the data base of the central entity with its local knowledge. A straightforward decision would be that it should always do it when the rewards from the local Q-table are greater than the rewards from the aggregated Q-table. However, sending Q-table entries over air interface may occupy significant network bandwidth such that it is important to quantify the difference between the rewards from the local Q-table and the rewards from the aggregated Q-table.

In step 730, when the local Q-table is selected, the user device determines that a predefined condition (e.g., a predefined transmitting condition) is present (i.e., verified).

In step 735, in response to determining that the predefined condition is present, transmits the local Q-table to the central entity (e.g., for updating the aggregated Q-table). In particular, the local Q-table is transmitted to the central entity over the air interface in response to determining that the predefined condition that a difference between the rewards from the local Q-table and the rewards from the aggregated Q-table is greater than a threshold parameter Δ is present. It means that the above difference between local Q-table and aggregated Q table is substantial enough to allow the aggregated Q-table of the central entity to be enriched with this knowledge from the user device. The threshold parameter Δ may comprise either a configurable parameter or a predefined parameter. The configurable parameter may be configured by the central entity (e.g., serving gNB or OAM entity) prior to being transmitting to the user device once entered the network, and the predefined parameter may be a user device vendor specific parameter. The threshold parameter Δ may represent the quality level of the new Q-table (i.e., the local Q-table) with respect to the initial Q-table (i.e., the aggregated Q-table) and be a trigger to start federated learning at the central entity based on an appropriate value of A. An appropriate value of A may be computed based on history of user device triggers for federated learning and be used as to allow the user devices to contribute to aggregated federated learning model without unnecessary wasting too many communication and computational resources when frequently starting federated learning.

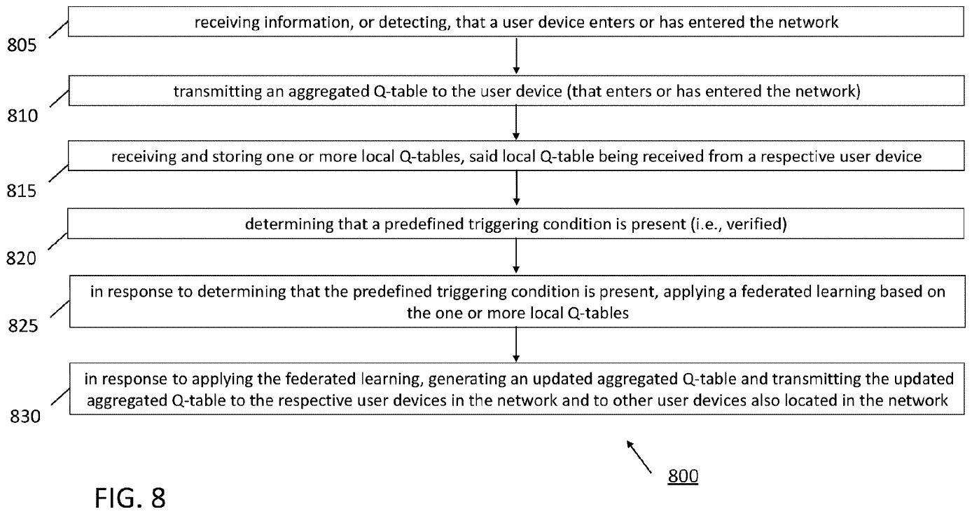

FIG. 8 shows an example embodiment of a flow chart describing a method 800 of the multi-agent federated learning RL solution for UL PDCP split at the network side.

In step 805, a central entity (e.g., a serving gNB or an OAM entity (or more specifically a RIC) via its serving gNB) located in a network receives information, or detects, that a user device (e.g., a UE) enters or has entered the network.

In step 810, the central entity transmits an aggregated Q-table to the user device, as described in the above method 700, that enters or has entered the network.

In step 815, the central entity receives and stores one or more local Q-tables in its database, said local Q-table (e.g., each local Q-table) being received from a respective user device (e.g., when the predefined (transmitting) condition of transmitting a local Q-table from the respective user device to the central entity is determined to be present (i.e., verified) at the user device).

In step 820, the central entity determines that a predefined triggering condition is present (i.e., verified).

In step 825, in response to determining that the predefined triggering condition is present, the central entity applies a federated learning based on the one or more Q-tables, i.e., more specifically the central entity applies a federated learning based model aggregation on the received local Q-tables.

In step 830, in response to applying the federated learning, the central entity generates an updated aggregated Q-table and transmits the updated aggregated Q-table to the respective user devices (e.g., to each of the respective user devices) in the network and to other user devices also located in the network (i.e., not only the newly entered user device(s) but also other user devices having previously entered the network) or each of any other user devices also located in the network (i.e., to all user devices located in the network: not only the newly entered user device(s) but also all other user devices having previously entered the network).

The step of applying the federated learning may comprise aggregating the one or more local Q-tables and updating the aggregated Q-table based on the one or more local Q-tables as to obtain the updated aggregated Q-table. Thereby, a converged aggregated Q-table may be created.

As above-mentioned, the federated learning is applied in response to determining that the predefined triggering condition is present such that the central entity does not immediately start a new round of Q-table aggregation. Indeed, one time aggregation of Q-learning tables might cause bias in the aggregated Q-table. It is the reason why federated learning is employed, which runs multiple rounds of Q-table aggregation between the central entity and the local learners (i.e., the user devices of the network) before a converged aggregated Q-table is created and transmitted to user devices in the network or all user devices in the network in order to improve local performance of these local learners. Multiple iterations of federated learning require a lot of computational resources, both at the central entity as well as at the local learners (i.e., the user devices), and consumes large bandwidth for data communication. Therefore, upon receipt of a local Q-table from the user device, the central entity at the network side does not immediately start a next round of federated learning but follows a policy on when it should start a new round of federated learning. For example, the federated learning may be applied in response to determining that the predefined triggering condition that a number of the received one or more local Q-tables is above a predefined threshold value is present, thereby implying that there is a large number of user devices in the network having their local Q-tables different from the aggregated Q-table from the central entity with a difference in rewards of a threshold parameter Δ or higher, and/or in response to determining that a timer has just expired is present, thereby indicating the starting point when the central entity can initiate a new round of federated learning periodically. Thus, when the predefined triggering condition is present, a new round of federated learning is started in which user devices in the network (i.e., not only the new user devices entering the network but also other user devices already located in the network) or all (i.e., not only all new user devices entering the network but also all other user devices already located in the network) of the user devices in the network contribute their local Q-tables again and in which a fresh aggregated Q-table is generated by the central entity based on the individual contribution of the local Q-tables again computed by these user devices.

The central entity may be located or implemented in the network either inside a serving gNB (e.g., a base station) for the respective user devices, or outside the serving gNB, e.g., inside an OAM entity (e.g., more specifically a RIC in the case of an open radio access network (O-RAN) scenario), the serving gNB relaying RL information (e.g., aggregated Q-table, optional configurable parameter Δ) from the OAM entity towards the user device and RL information (e.g., local Q-table) from the user device towards the OAM entity. In short, operations, administration and management or operations, administration and maintenance (OAM) may be defined as the processes, activities, tools, and standards involved with operating, administering, managing and maintaining any system, and more specifically, a RIC may be defined as a software-defined component of the O-RAN architecture that is responsible for controlling and optimizing RAN functions.

It should be noted that the existing 5G wireless architecture may lack sufficient flexibility and intelligence to efficiently handle demands including, e.g., enhanced mobile broadband (eMBB), ultra-reliable and low-latency communications (uRLLC), and massive machine type communications (mMTC). As a result, the evolution towards beyond 5G and sixth generation (6G) wireless calls for an architectural transformation required to support service heterogeneity, coordination of multi-connectivity technologies, and on-demand service deployment. And O-RAN appears to be an emerging idea that enables such an architectural transformation using the concepts of virtualization, flexibility, and intelligence.

It should be also noted that 6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication, distributed ledgers and blockchain technologies. Key features of 6G will include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

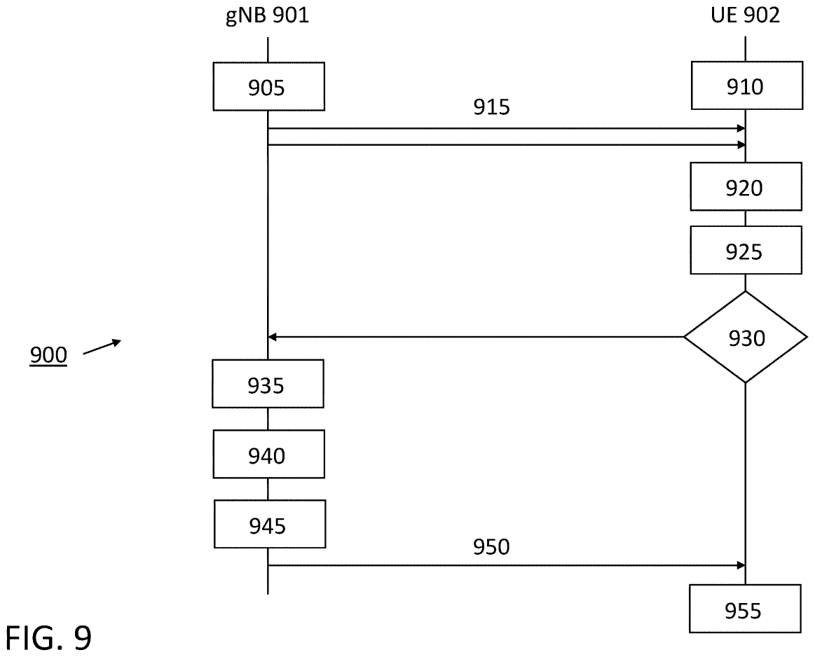

FIG. 9 shows an example embodiment of a signaling diagram 900 for a signaling between a UE device 902 as a user device and a gNB entity 901 (e.g., a base station) as a central entity for a method of the multi-agent federated learning RL solution for UL PDCP split.

At 905, the central policy π at the gNB entity 901 is maintained.

At 910, the UE device 902 enters the network where the (serving) gNB entity 901 is located.

At 915, once the UE device 902 has entered the network, the gNB entity 901 transmits an aggregated Q_{g}-table, and optionally a configurable parameter Δ, to the UE device 902.

At 920, the UE device 902 receives the aggregated Q_{g}-table and applies the central policy IT.

At 925, the UE device 902 generates a local Qₖ-table.

At 930, the UE device 902 determines that a predefined condition is present (i.e., verified), and in response to determining that the predefined condition is present, the UE device 902 transmits the local Qₖ-table to the gNB entity 901 (e.g., for updating the aggregated Q_{g}-table).

At 935, the gNB entity 901 determines that a predefined triggering condition is present (i.e., verified) for applying a federated learning based on the received local Qₖ-tables.

At 940, in response to determining that the predefined triggering condition is present, the gNB entity 901 applies the federated learning by aggregating the received local Qₖ-tables from multiple UE devices 902 in the network.

At 945, upon completion of the federated learning, the gNB entity 901 transmits a resulting “updated” aggregated Q_{g}-table to UE devices 902 located in the network or all UE devices 902 located in the network.

At 950, the gNB entity 901 transmits the “updated” aggregated Q_{g}-table to the UE device 902.

At 955, the UE device 902 receives the “updated” aggregated Q_{g}-table and applies the central policy TT.

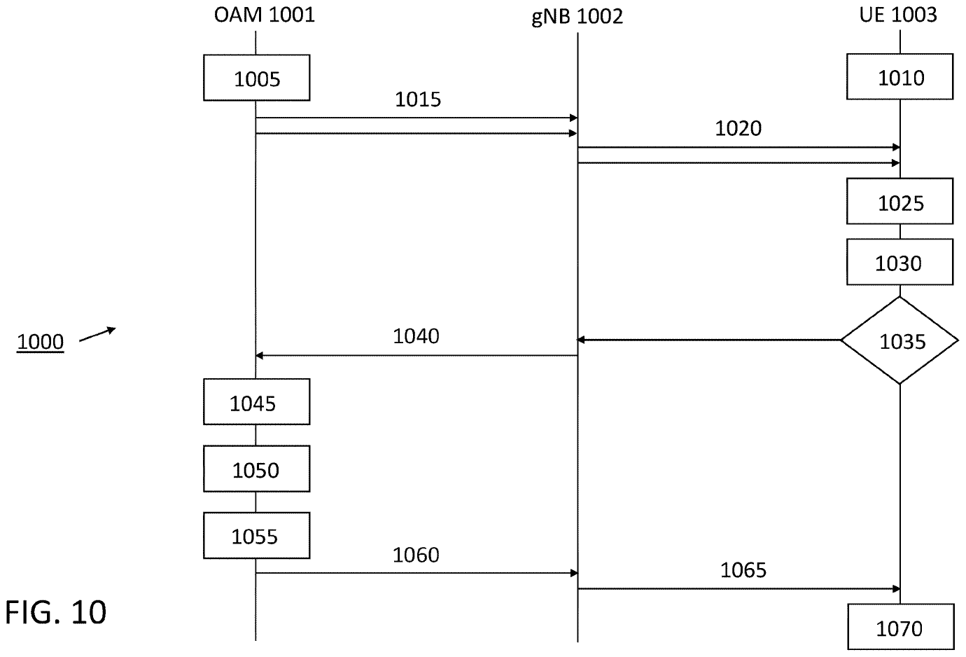

FIG. 10 shows an example embodiment of a signaling diagram 1000 for a signaling between a UE device 1003 as a user device and an OAM entity 1001 (e.g., more specifically a RIC) as a central entity via a (serving) gNB entity 1002 (e.g., a base station) for a method of the multi-agent federated learning RL solution for UL PDCP split.

At 1005, the central policy π at the OAM entity 1001 is maintained.

At 1010, the UE device 1003 enters the network where the serving gNB entity 1002 is located.

At 1015, the OAM entity 1001 receives information, or detects, that the UE device 1003 enters or has entered the network, and in response the OAM entity 1001 transmits an aggregated Q_{g}-table, and optionally a configurable parameter Δ, to the gNB entity 1002.

At 1020, the gNB entity 1002 relays the aggregated Q_{g}-table, and optionally the configurable parameter Δ, to the UE device 1003.

At 1025, the UE device 1003 receives the aggregated Q_{g}-table from the OAM entity 1001 via the gNB entity 1002 and applies the central policy TT.

At 1030, the UE device 1003 generates a local Qₖ-table.

At 1035, the UE device 1003 determines that a predefined condition is present (i.e., verified), and in response to determining that the predefined condition is present, the UE device 1003 transmits the local Qₖ-table to the gNB entity 1002.

At 1040, the gNB entity 1002 relays the local Qₖ-table to the OAM entity 1001 (e.g., for updating the aggregated Q_{g}-table).

At 1045, the OAM entity 1001 determines that a predefined triggering condition is present (i.e., verified).

At 1050, in response to determining that the predefined triggering condition is present, the OAM entity 1001 applies the federated learning based on the received local Qₖ-tables by aggregating the received local Qₖ-tables from multiple UE devices 1003 in the network.

At 1055, upon completion of the federated learning, the OAM entity 1001 transmits a resulting “updated” aggregated Q_{g}-table to UE devices 1003 located in the network or all UE devices 1003 located in the network, first via the gNB entity 1002.

At 1060, the “updated” aggregated Q_{g}-table is transmitted to the gNB entity 1002.

At 1065, the gNB entity 1002 relays the “updated” aggregated Q_{g}-table to the UE device 1003.

At 1070, the UE device 1003 receives the “updated” aggregated Q_{g}-table and applies the central policy TT.

It should be noted that radio resource control (RRC) signaling is used for transmission/receipt between the gNB entity 901 and the UE device 902 in FIG. 9 and between the OAM entity 1001, the gNB entity 1002, and the UE device 1003 in FIG. 10. Optionally, service data adaptation protocol (SDAP) signaling instead of RRC signaling may be used for the transfer of the aggregated Q_{g}-table and local Qₖ-table.

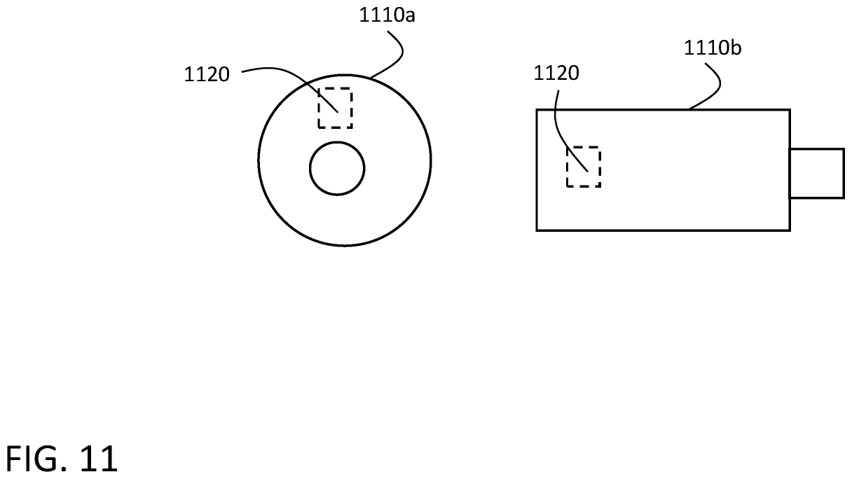

FIG. 11 shows an example embodiment of non-transitory computer readable media 1110a (e.g., a computer disc (CD) or a digital versatile disc (DVD)) and 1110b (e.g., a universal serial bus (USB) memory stick), which are configured to store instructions and/or parameters 1120 that, when executed by a processor, allow the processor to perform one or more of the steps of any of the methods of any of the disclosed embodiments. It should be noted that the term “non-transitory”, as used herein, is a limitation of the medium itself (i.e., tangible, not a signal) as opposed to a limitation on data storage persistency (e.g., random access memory, RAM, versus read-only memory, ROM).

It should be appreciated that, while the above has described some example embodiments, there are several variations and modifications which may be made to the disclosed solution without departing from the scope of the present application.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any of the above procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

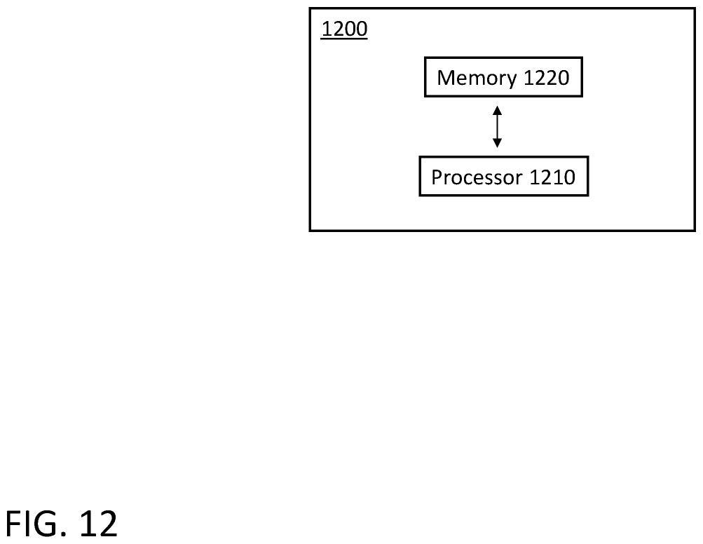

FIG. 12 shows an example embodiment of an apparatus 1200, which may be provided in the central unit (CU) of the user device, in particular in the PDCP layer of the CU, e.g., at splitter level. The apparatus 1200 may comprise at least one processor 1210 and at least one memory 1220 including computer code for one or more programs. The apparatus 1200 may be configured to cause one or more of the steps of any of the methods of any of the embodiments to be performed.

Alternatively or additionally, some embodiments may be implemented using circuitry. The circuitry may be configured to perform one or more of the functions and/or method steps previously described. That circuitry may be provided, for example, in the CU of the user device, in particular in the PDCP layer of the CU, e.g., at splitter level, or in the apparatus 1200 provided in the PDCP layer.

As used in the present application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example, integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1-25. (canceled)

26. A user device comprising:
at least one processor; and
at least one memory storing instructions that, when executed by the at least one processor, cause the user device at least to:
receive a packet data unit, PDU, of one or more incoming PDUs to be transmitted by the user device, via a respective path, to one amongst a master node and at least one secondary node;
receive, once entered a network, an aggregated Q-table from a central entity of the network, the aggregated Q-table including rewards and being shared with the user device and with other user devices also located in the network;
perform a local exploration during a certain time interval using the aggregated Q-table, and generate, in response to the local exploration, a local Q-table, the local Q-table including rewards;
compare the respective rewards from the aggregated Q-table and the local Q-table;
based on said comparison, select to use after the certain time interval either the aggregated Q-table or the local Q-table for making a decision to select the respective path for transmitting the PDU; and
when the local Q-table is selected, determine that a predefined condition is present, and in response to determining that the predefined condition is present, transmit the local Q-table to the central entity.

27. The user device of claim 26, wherein the local exploration is a local reinforcement learning, RL, exploration.

28. The user device of claim 26, wherein:
the aggregated Q-table is selected if the rewards from the aggregated Q-table are greater than the rewards from the local Q-table, and
the local Q-table is selected if the rewards from the local Q-table are equal to or greater than the rewards from the aggregated Q-table.

29. The user device of claim 28, wherein, when the local Q-table is selected, the local Q-table is transmitted to the central entity in response to determining that the predefined condition that is that a difference between the rewards from the local Q-table and the rewards from the aggregated Q-table is greater than a threshold parameter is present.

30. The user device of claim 29, wherein the threshold parameter comprises one amongst a configurable parameter and a predefined parameter.

31. The user device of claim 30, wherein the instructions, when executed by the at least one processor, cause the user device at least to receive, once entered the network, the configurable parameter from the central entity of the network.

32. A central entity comprising:
at least one processor; and
at least one memory storing instructions that, when executed by the at least one processor, cause the central entity located in a network at least to:
receive information that a user device enters the network;
transmit an aggregated Q-table to the user device;
receive and store one or more local Q-tables, said local Q-table being received from a respective user device;
determine that a predefined triggering condition is present;
in response to determining that the predefined triggering condition is present, apply a federated learning based on the one or more local Q-tables; and
in response to applying the federated learning, generate an updated aggregated Q-table and transmit the updated aggregated Q-table to the respective user devices in the network and to other user devices also located in the network.

33. The central entity of claim 32, wherein the step of applying the federated learning comprises aggregating the one or more local Q-tables and updating the aggregated Q-table based on the one or more local Q-tables as to obtain the updated aggregated Q-table.

34. The central entity of claim 32, wherein the federated learning is applied in response to determining that the predefined triggering condition that a number of the one or more local Q-tables is above a threshold value is present and/or that the predefined triggering condition that a timer has just expired is present.

35. The central entity of claim 32, wherein the central entity is located in the network either inside a serving base station for the respective user devices or inside an operations, administration and maintenance, OAM, entity or inside a radio access network intelligent controller, RIC.

36. A method performed at a user device, the method comprising:
receiving a packet data unit, PDU, of one or more incoming PDUs to be transmitted by the user device, via a respective path, to one amongst a master node and at least one secondary node;
receiving, once the user device has entered a network, an aggregated Q-table from a central entity of the network, the aggregated Q-table including rewards and being shared with the user device and with other user devices also located in the network;
performing a local exploration during a certain time interval using the aggregated Q-table comprising one or more rewards, and generating, in response to the local exploration, a local Q-table, the local Q-table comprising rewards;
comparing the respective rewards from the aggregated Q-table and the local Q-table;
based on said comparison, selecting to use after the certain time interval either the aggregated Q-table or the local Q-table for making a decision to select the respective path for transmitting the PDU; and
when the local Q-table is selected, determining that a predefined condition is present, and in response to determining that the predefined condition is present, transmitting the local Q-table to the central entity.

37. The method of claim 36, wherein the local exploration is a local reinforcement learning, RL, exploration.

38. The method of claim 36, wherein:
the aggregated Q-table is selected if the rewards from the aggregated Q-table are greater than the rewards from the local Q-table, and
the local Q-table is selected if the rewards from the local Q-table are equal to or greater than the rewards from the aggregated Q-table.

39. The method of claim 38, wherein, when the local Q-table is selected, the local Q-table is transmitted to the central entity in response to determining that the predefined condition that a difference between the rewards from the local Q-table and the rewards from the aggregated Q-table is greater than a threshold parameter is present.

40. The method of claim 39, wherein the threshold parameter comprises one amongst a configurable parameter and a predefined parameter.

41. The method of claim 40, further comprising receiving, once the user device has entered the network, the configurable parameter from the central entity of the network.
